(19) United States
(12) Patent Application Publication
(10) Pub. No.: US 2025/0260030 A1
(43) Pub. Date: Aug. 14, 2025

(54) PFUEL CONDUCTING DEVICE FOR CONDUCTING FUEL, FUEL CELL ASSEMBLY, AND WATERCRAFT

(71) Applicant: Rolls-Royce Solutions GmbH, Friedrichshafen (DE)

(72) Inventors: Benjamin Oszfolk, Friedrichshafen (DE); Alexander Gomeringer, Owingen (DE)

(73) Assignee: Rolls-Royce Solutions GmbH, Friedrichshafen (DE)

(21) Appl. No.: 19/192,996

(22) Filed: Apr. 29, 2025

Related U.S. Application Data
(63) Continuation of application No. PCT/EP2023/053911, filed on Feb. 16, 2023.

(30) Foreign Application Priority Data
Nov. 4, 2022 (DE) 10 2022 129 236.3
Feb. 16, 2023 (WO) PCT/EP2023/053911

(51) Int. Cl. H01M 8/04082; B63H 21/00; B63H 21/38; H01M 8/04089; H01M 8/04186; H01M 8/0438; H01M 8/04746; H01M 8/04955

(52) U.S. Cl. CPC H01M 8/04201; B63H 21/00; B63H 21/38; H01M 8/04089; H01M 8/04186; H01M 8/04425; H01M 8/04776; H01M 8/04955; B63H 2021/003; H01M 2250/20

(57) ABSTRACT

A fuel conducting device for conducting a fuel includes: a line which includes a core line and an encasement space surrounding the core line, the core line being configured for conducting the fuel, the encasement space being configured for being filled with a liquid encasement space medium; and a conveyor device which is fluidically connected with the encasement space, the conveyor device being configured for conveying the liquid encasement space medium into the encasement space.

### CROSS REFERENCE TO RELATED APPLICATIONS

This is a continuation of PCT application no. PCT/EP2023/053911, entitled “FUEL CONDUCTING DEVICE FOR CONDUCTING A FUEL, FUEL CELL ASSEMBLY, AND WATERCRAFT”, filed Feb. 16, 2023, which is incorporated herein by reference. PCT application no. PCT/EP2023/053911 claims priority to German patent application no. 10 2022 129 236.3, filed Nov. 4, 2022, which is incorporated herein by reference.

### BACKGROUND OF THE INVENTION

### 1. Field of the Invention

The present invention relates to fuel conducting devices.

### 2. Description of the Related Art

A gaseous fuel, in particular hydrogen, or a liquid fuel, in particular methanol, can have a high vapor pressure and a low boiling point. Because of the high vapor pressure, a mechanical failure in the integrity of the storage device or transportation device can occur during storage or transportation of the gaseous or liquid fuel, in particular during additional heating of a storage device or transportation device, which could result in damage.

The classification society DNV basically describes two methods as to how gaseous or liquid fuels, in particular those fuels having a low flash point, in particular hydrogen or methanol, can be conducted. Normally, a double-walled line is used. Such a line has a core line and a fillable encasement space or alternatively a flushable jacketed line. The gaseous or liquid fuel is conducted in the core line. Depending on the method selected, the encasement space is filled with an inert gas, in particular nitrogen, or the jacketed line is flushed with air. Filling with inert gas, in particular nitrogen, is expensive and complex, because in addition to a gas-compatible filling system, inert gas, in particular nitrogen, is also used as a fuel. Moreover, the gas-tightness of the entire line must be ensured and continuously monitored. When flushing with air, an inert gas, in particular nitrogen, is dispensed with. However, conversely a flushing device is required which continuously flushes the jacketed line. This is energy intensive and expensive.

It would thus be desirable, to be able to conduct a gaseous or liquid fuel easily and safely without a complex flushing process and without provision of an additional fuel, in particular an inert gas, in particular nitrogen.

What is needed in the art is a fuel conducting device for conducting in particular a gaseous or liquid fuel, a fuel cell arrangement with such a fuel conducting device, and a watercraft with such a fuel conducting device and/or such a fuel cell arrangement, wherein the aforementioned disadvantages are reduced, optionally eliminated.

### SUMMARY OF THE INVENTION

The invention relates to a fuel conducting device for conducting in particular a gaseous fuel, in particular hydrogen or in particular a liquid fuel, in particular methanol, a fuel cell arrangement with such a fuel conducting device and a watercraft with such a fuel conducting device and/or such a fuel cell arrangement.

The present invention provides a fuel conducting device for conducting in particular a gaseous or liquid fuel. The fuel conducting device includes a line and a conveyor device. The line has a core line and an encasement space surrounding the core line. The core line is designed to conduct the fuel. The encasement space is designed to be filled with a liquid encasement space medium. The conveyor device is fluidically connected with the encasement space. The conveyor device is designed to convey the liquid encasement space medium into the encasement space, in particular to fill the encasement space with the liquid encasement space medium, in particular to fill it completely. In this way, the in particular gaseous or liquid fuel can be easily and safely conducted. Moreover, a flushing device for continuous, energy intensive and voluminous flushing of the jacketed line is eliminated.

In the context of the present technical teaching, a gaseous fuel is understood to be in particular a fuel that is gaseous at 25° C. and 1013 mbar, in particular having a low flash point, in particular according to SOLAS-regulation 11-2/4.2.

In the context of the present technical teaching, a liquid fuel is understood to be in particular a fuel that is liquid at 25° C. and 1013 mbar, in particular having a low flash point, in particular according to SOLAS-regulation 11-2/4.2.

The gaseous fuel is, in particular, hydrogen. The liquid fuel is, in particular, methanol.

In the context of the present technical teaching, a liquid encasement space medium is understood, in particular, to be a medium that is liquid at 25° C. and 1013 mbar.

In particular, the liquid encasement space medium is water.

The core line is restricted in particular by a first wall, which delimits the core line from the encasement space. The encasement space is restricted, in particular, by the first wall and by a second wall, by the wall surrounding the core line, in particular by a jacketed tube.

The conveyor device is in particular a pump, in particular a flow pump or a displacement pump.

The encasement space has, in particular, a vent opening. The vent opening is designed, in particular, to allow gas, in particular air contained in the encasement space, to escape from the encasement space while the liquid encasement space medium is conveyed into the encasement space. The vent opening is designed, in particular, to close, in particular to close after the gas, in particular air, has escaped from the encasement space. The encasement space includes in particular a plurality of vent openings.

According to a further development of the present invention, it is provided that the fuel conducting device includes a shut-off device. The shut-off device is designed to selectively shut off a fluidic connection between the conveyor device and the encasement space in a shut-off state, or to release it in a release state. Thereby it can be advantageously ensured after filling of the encasement space, that the encasement space medium remains in the encasement space—without further operation of the conveyor device—and that, in particular, a predetermined pressure is maintained.

The shut-off device is in particular a shut-off valve or a stopcock. The shut-off device has in particular a drive which is designed to shut off or release the shut-off device.

According to a further development of the present invention, it is provided that the fuel conducting device includes a storage collecting device for the liquid encasement space medium. The storage collecting device is fluidically connected with the conveyor device so that the liquid encasement space medium can be conveyed by the conveyor device from the storage collecting device into the encasement space. In this way, the encasement space medium necessary for filling of the encasement space can be provided especially easily.

The storage collecting device is in particular a tank or a container.

According to a further development of the present invention it is provided that the fuel conducting device includes a pressure measuring device and a control device. The pressure measuring device is designed to measure an actual pressure in the encasement space. The control device is operatively connected with the conveyor device, the pressure measuring device and the shut-off device and is designed, depending on the actual pressure, to switch the conveyor device between a conveying state, in which the conveyor device conveys the encasement space medium, and an idle state, in which the conveyor device is switched off, and to switch the shut-off device between the release state and the shut-off state. By way of the control device it is advantageously possible to operate the fuel conducting device partially or fully automatically.

The pressure measuring device is arranged in particular at the fuel conducting device, in order to detect the actual pressure in the encasement space. The actual pressure is in particular a momentary actual pressure in the encasement space.

In the context of the present technical teaching, the fact that the control device is designed to switch the conveyor device and the shut-off device depending on the actual pressure means, in particular, that the control device is designed to detect the actual pressure, to compare it with at least one predetermined target pressure threshold value and, based on the comparison, to switch the conveyor device and the shut-off device between the respective assigned states.

According to a further development of the present invention, it is provided that the control device is additionally designed: depending on the actual pressure, in a start state to switch the shut-off device into the release state and/or to switch the conveyor device into the conveying state; in a stop state, to switch the shut-off device into the shut-off state and to switch the conveyor device into the idle state; and, in an emergency shut-off state, to switch off the system that is supplied with fuel via the fuel conducting device. In this way, partial or fully automatic monitoring of the actual pressure during operation of the fuel conducting device is advantageously possible. It is moreover advantageously possible that the fuel conducting device can be operated in different operating modes. The system can furthermore be advantageously switched off partially or fully automatically in an emergency state, in particular in the event of a fuel leak so that, in particular, damage can be avoided.

In particular, the start state is a state in which the system that is operatively connected with the fuel conducting device is switched on or should be switched on. In the start state, in particular, the actual pressure is lower than a first predetermined target pressure threshold value. In particular, in the start state the conveyor device conveys the encasement space medium into the encasement space until the actual pressure reaches or exceeds the first predetermined target pressure threshold value. If the actual pressure reaches or exceeds the first predetermined target pressure threshold value, the control device changes in particular into the stop state.

The first target pressure threshold value is greater in particular than a predetermined or actual pressure value of the fuel in the core line. In this way it is avoided that fuel can leak from the core line into the encasement space.

In particular, the actual pressure in the emergency shut down state is lower than a second predetermined target pressure threshold value. In one embodiment, the first and the second predetermined target pressure threshold value are selected to be the same. In another embodiment, the first and the second predetermined target pressure threshold value are selected to be different. In particular, the second predetermined target pressure threshold value is less than the first predetermined target pressure threshold value in order to provide a type of hysteresis for the stop state and to prevent switching too quickly. In particular, the control device switches to the emergency shutdown state, when the actual pressure drops below the second predetermined target pressure threshold value, when it displays in particular a negative pressure gradient when scanning the second predetermined target pressure threshold value. The second predetermined target pressure threshold value is lower than the first predetermined target pressure threshold value and greater than the predetermined actual pressure value of the fuel in the core line. It is thus prevented, even in the event of a leak that fuel can leak from the core line into the encasement space. Instead, encasement space medium enters into the core line in this case.

The present invention also provides a fuel cell arrangement with at least one fuel cell and with one inventive fuel conducting device or with a fuel conducting device according to one or a number of the previously described embodiments. A supply connection of the at least one fuel cell is fluidically connected with the core line, so that fuel can be supplied to the at least one fuel cell by way of the core line for use in the at least one fuel cell. The at least one fuel cell is arranged to convert the fuel into the encasement space medium, in particular as an electrochemical reaction product. The discharge connection of the at least one fuel cell is fluidically connected with the conveyor device, so that the encasement space medium created in the fuel cell can be conveyed into the encasement space. In connection with the fuel cell arrangement, advantages result in particular which were already previously discussed in connection with the fuel conducting device. Also, an already available and therefore cost-neutral or at least low-cost product of the fuel cell is advantageously used as encasement space medium, thus being able to dispense with an additional and in particular expensive fuel.

According to a further development of the present invention, it is provided that the discharge connection is fluidically connected with the storage collecting device so that draining encasement space medium can be directed into the storage collecting device. In this way, a buffer stock of encasement space medium is advantageously provided.

According to a further development of the present invention, it is provided that the control device is arranged to switch off the at least one fuel cell in the emergency shutdown state. This advantageously ensures safe and partial or fully automatic operation of the fuel cell. The fuel cell is in particular protected from operating at a fuel pressure that is too low and from the encasement space medium penetrating into the supply connection via a leak in the core line.

The at least one fuel cell is switched off in particular by the control device in the emergency shutdown state if, for example, the first wall is damaged and due to this, the core line has an opening, so that the encasement space medium can flow from the encasement space through the opening into the core line. This causes, in particular a reduction of the actual pressure in the encasement space to below the second predetermined target pressure threshold value, so that the system that is operatively connected with the fuel conducting device, in particular the fuel cell, is shut off.

The present invention also provides a watercraft with an inventive fuel conducting device or with a fuel conducting device according to one or a number of the previously described embodiments and/or with at least one fuel cell arrangement according to the present invention or with a fuel cell arrangement according to one or a number of the previously described embodiments. Advantages result in particular in connection with the watercraft which were already explained in connection with the fuel conducting device and the fuel cell arrangement.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawing, wherein:

FIG. 1 is a schematic representation of a design example of a watercraft, with a fuel cell arrangement and a fuel conducting device.

Corresponding reference characters indicate corresponding parts throughout the several views. The exemplification set out herein illustrates at least one embodiment of the invention, and such exemplification is not to be construed as limiting the scope of the invention in any manner.

### DETAILED DESCRIPTION OF THE INVENTION

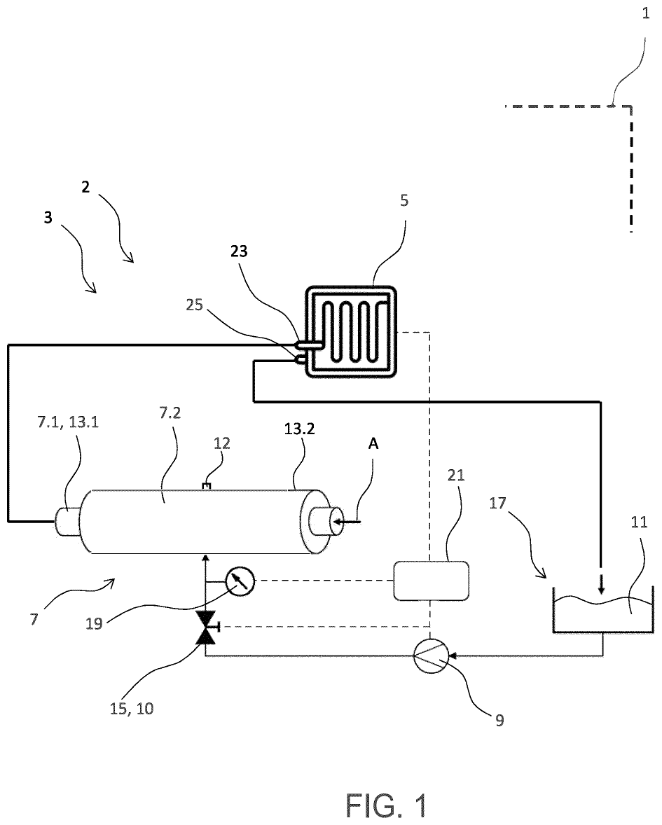

The only drawing, FIG. 1, shows a design example of a watercraft 1 with a fuel cell arrangement 2, which has a fuel conducting device 3 and at least one fuel cell 5.

Fuel conducting device 3 has a line 7 and a conveyor device 9. Line 7 has a core line 7.1 and an encasement space 7.2 surrounding core line 7.1. Core line 7.1 is designed to—as illustrated by arrow A—conduct the fuel. Encasement space 7.2 is arranged to be filled with a liquid encasement space medium 11. Conveyor device 9 is fluidically connected with encasement space 7.2. Conveyor device 9 is designed to convey liquid encasement space medium 11 into encasement space 7.2 and to optionally fill encasement space 7.2 with liquid encasement space medium 11, optionally to fill it completely.

Core line 7.1 is optionally restricted by a first wall 13.1 which delimits core line 7.1 from encasement space 7.2. Encasement space 7.2 is optionally limited by first wall 13.1 and second wall 13.1, in particular by a jacketed tube.

Conveyor device 9 is optionally a pump, optionally a flow pump or a displacement pump.

Encasement space 7.2 optionally has a vent opening 12. Vent opening 12 is arranged optionally to allow a gas, optionally air contained in encasement space 7.2 to escape from encasement space 7.2 when liquid encasement space medium 11 is conveyed into encasement space 7.2. Vent opening 12 is optionally designed to be closed, optionally to be closed after gas, optionally air, has escaped from encasement space 7.2. Encasement space 7.2 has a plurality of vent openings 12.

It is optionally provided that fuel conducting device 3 includes a shut-off device 15. Shut-off device 15 is arranged to selectively shut off a fluidic connection between conveyor device 9 and encasement space 7.2 in a shut-down state and to release it in a release state.

Shut-off device 15 is optionally a shut-off valve or a stopcock. Shut-off device 15 optionally has a drive 10 which is designed to shut off or to release shut-off device 15.

It is optionally provided that fuel conducting device 13 has a storage collecting device 17 for liquid encasement space medium 11. Storage collecting device 17 is fluidically connected with conveyor device 9 so that liquid encasement space medium 11 can be conveyed by conveyor device 9 from storage collecting device 17 into encasement space 7.2.

Storage collecting device 17 is in particular a tank or a container.

It is optionally provided that fuel conducting device 3 has a pressure measuring device 19 and a control device 21. Pressure measuring device 19 is designed to measure an actual pressure in encasement space 7.2. Control device 21 is operatively connected with conveyor device 9, pressure measuring device 19, and shut-off device 15 and is designed, depending on the actual pressure, to switch conveyor device 9 between a conveying state, in which conveyor device 9 conveys encasement space medium 11, and an idle state, in which conveyor device 9 is switched off, and to switch shut-off device 15 between the release state and the shut-off state.

Pressure measuring device 19 is optionally fluidically connected with encasement space 7.2. The actual pressure is optionally a momentary actual pressure in encasement space 7.2.

Control device 21 is designed in particular, depending on the actual pressure, in a start state to switch shut-off device 15 into the release state and/or to switch conveyor device 9 into the conveying state, in a stop state to switch shut-off device 15 into the shut-off state and to switch the conveyor device 9 into the idle state, and in an emergency shut-down state to switch off fuel cell 5 which is operatively connected with fuel conducting device 3.

The start state is optionally a state in which fuel cell 5 is switched on or is to be switched on. In the start state, the actual pressure is optionally lower than a first predetermined target pressure threshold value. In the start state, conveyor device 9 optionally conveys encasement space medium 11 into encasement space 7.2 until the actual pressure reaches or exceeds the first predetermined target pressure threshold value. If the actual pressure reaches or exceeds the first predetermined target pressure threshold value, the control device changes optionally into the stop state.

The first target pressure threshold value is optionally greater than a predetermine or actual pressure value of the fuel in core line 7.1. In this way it is avoided that fuel can leak from core line 7.1 into encasement space 7.2.

The actual pressure in the emergency shut down state is optionally lower than a second predetermined target pressure threshold value. In one embodiment, the first and the second predetermined target pressure threshold values are selected to be the same. In another embodiment, the first and the second predetermined target pressure threshold values are selected to be different. The second predetermined target pressure threshold value is optionally lower than the first predetermined target pressure threshold value in order to provide a type of hysteresis for the stop state and to prevent switching too quickly. Control device 21 optionally switches to the emergency shutdown state when the actual pressure drops below the second predetermined target pressure threshold value, thus representing in particular a negative pressure gradient when scanning the second predetermined target pressure threshold value. The second predetermined target pressure threshold value is lower than the first predetermined target pressure threshold value and greater than the predetermined actual pressure value of the fuel in core line 7.1. It is thus prevented, even in the event of a leak that fuel can leak from core line 7.1 into encasement space 7.2. Instead, encasement space medium 11 enters into core line 7.1 in this case.

A supply connection 23 of the at least one fuel cell 5 is fluidically connected with core line 7.1, so that fuel can be supplied—as illustrated by arrow A—to the at least one fuel cell 5 via core line 7.1 for use in the at least one fuel cell 5. The at least one fuel cell 5 is arranged to convert the fuel into encasement space medium 11 as an electrochemical reaction product. Discharge connection of the at least one fuel cell 5 is fluidically connected with conveyor device 9, so that encasement space medium 11 created in fuel cell 5 can be conveyed into encasement space 7.2.

The at least one fuel cell 5 is optionally switched off in particular by control device 21 in the emergency shutdown state if, for example, first wall 13.1 is damaged and, due to this, core line 7.1 has an opening, so that encasement space medium 11 can flow from encasement space 7.2 through the opening into core line 7.1. This optionally causes a reduction of the actual pressure in the encasement space 7.2 to below the second predetermined target pressure threshold value, so that the system that is operatively connected with fuel conducting device 3, in particular fuel cell 5, is shut off.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A fuel conducting device for conducting a fuel, the fuel conducting device comprising:
a line which includes a core line and an encasement space surrounding the core line, the core line being configured for conducting the fuel, the encasement space being configured for being filled with a liquid encasement space medium; and
a conveyor device which is fluidically connected with the encasement space, the conveyor device being configured for conveying the liquid encasement space medium into the encasement space.

2. The fuel conducting device according to claim 1, further including a shut-off device configured for:
(a) selectively shutting off a fluidic connection between the conveyor device and the encasement space in a shut-off state; or
(b) releasing the fluidic connection between the conveyor device and the encasement space in a release state.

3. The fuel conducting device according to claim 2, further including a storage collecting device configured for storing liquid encasement space medium, the storage collecting device being fluidically connected with the conveyor device such that the conveyor device is configured for conveying the liquid encasement space medium from the storage collecting device into the encasement space.

4. The fuel conducting device according to claim 2, further including:
(a) a pressure measuring device configured for measuring an actual pressure in the encasement space; and
(b) a control device which is operatively connected with the conveyor device, the pressure measuring device, and the shut-off device, the control device being configured, depending on the actual pressure, for:
(i) switching the conveyor device between a conveying state and an idle state, the conveyor device, in the conveying state, being configured for conveying the encasement space medium, the conveyor device, in the idle state, being configured for being switched off; and
(ii) switching the shut-off device between the release state and the shut-off state.

5. The fuel conducting device according to claim 4, wherein the control device is additionally configured, depending on the actual pressure, for:
(a), in a start state, at least one of (i) switching the shut-off device into the release state and (ii) switching the conveyor device into the conveying state;
(b), in a stop state, (i) switching the shut-off device into the shut-down state and (ii) switching the conveying device into the idle state; and
(c), in an emergency shut-off state, switching off a system which is supplied with the fuel and which is operatively connected with the fuel conducting device.

6. A fuel cell arrangement, comprising:
at least one fuel cell including a supply connection and a discharge connection; and
a fuel conducting device configured for conducting a fuel, the fuel conducting device including:
a line which includes a core line and an encasement space surrounding the core line, the core line being configured for conducting the fuel, the encasement space being configured for being filled with a liquid encasement space medium; and
a conveyor device which is fluidically connected with the encasement space, the conveyor device being configured for conveying the liquid encasement space medium into the encasement space, the supply connection of the at least one fuel cell being fluidically connected with the core line such that the fuel cell arrangement is configured for the fuel to be supplied to the at least one fuel cell by way of the core line for use in the at least one fuel cell, the at least one fuel cell being structured and arranged to convert the fuel into the liquid encasement space medium, the discharge connection of the at least one fuel cell being fluidically connected with the conveyor device such that the fuel cell arrangement is configured for the liquid encasement space medium, which is formed in the at least one fuel cell, to be conveyed into the encasement space.

7. The fuel cell arrangement according to claim 6, further including a storage collecting device, wherein the discharge connection is fluidically connected with the storage collecting device such that the fuel cell arrangement is configured for the liquid encasement space medium—which is draining—to be directed into the storage collecting device.

8. The fuel cell arrangement according to claim 6, further including a control device, which is structured and arranged to switch off the at least one fuel cell in an emergency shutdown state.

9. A watercraft, comprising:
at least one of:
(a) a fuel conducting device for conducting a fuel, the fuel conducting device including:
a line which includes a core line and an encasement space surrounding the core line, the core line being configured for conducting the fuel, the encasement space being configured for being filled with a liquid encasement space medium; and
a conveyor device which is fluidically connected with the encasement space, the conveyor device being configured for conveying the liquid encasement space medium into the encasement space; and
(b) a fuel cell arrangement, including:
at least one fuel cell including a supply connection and a discharge connection; and
the fuel conducting device, the supply connection of the at least one fuel cell being fluidically connected with the core line such that the fuel cell arrangement is configured for the fuel to be supplied to the at least one fuel cell by way of the core line for use in the at least one fuel cell, the at least one fuel cell being structured and arranged to convert the fuel into the liquid encasement space medium, the discharge connection of the at least one fuel cell being fluidically connected with the conveyor device such that the fuel cell arrangement is configured for the liquid encasement space medium, which is formed in the at least one fuel cell, to be conveyed into the encasement space.
